(19) United States
(12) Patent Application Publication
(10) Pub. No.: US 2006/0002264 A1
(43) Pub. Date: Jan. 5, 2006

(54) Recording/reproducing apparatus and method of copying digital contents

(75) Inventors: Kazuyo Hashiya, Tokyo (JP); Masahiro Ito, Gyoda-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/001,188

(22) Filed: Dec. 2, 2004

(30) Foreign Application Priority Data
Jun. 30, 2004 (JP) 2004-192881

(51) Int. Cl. G11B 15/52; G11B 5/09

(52) U.S. Cl. 369/47.12; 369/59.1

(57) ABSTRACT

A recording/reproducing apparatus and a method of copying digital contents are disclosed in which a request is given via a network to other recording/reproducing apparatuses connected via the network, to transmit information regarding lineups of own recording media; the information transmitted in response to the request is notified, thereby prompting a user to select an arbitrary recording medium; a request is given via the network to the apparatus having the selected recording medium, out of the other recording/reproducing apparatuses, to transmit information regarding a status thereof; it is judged, based on the information regarding the status transmitted in response to the request, whether or not the selected recording medium is allowed to be a dubbing destination of digital contents; and the digital contents are transmitted via the network to the recording/reproducing apparatus having the selected recording medium when the judgment results in permissibility as the dubbing destination.

### CROSS-REFERENCE TO RELATED APPLICATIONS

This application is based upon and claims the benefit of priority from the prior Japanese Patent Application No. 2004-192881, filed on Jun. 30, 2004; the entire contents of which are incorporated herein by reference.

### BACKGROUND

1. Field of the Invention

The present invention relates to a recording/reproducing apparatus capable of recording and reproducing the contents in a form of digital data on/from a recording medium and a method of copying the digital contents, and more particularly, to a recording/reproducing apparatus and a method of copying the digital contents which allow copying between apparatuses.

2. Description of the Related Art

Apparatuses capable of recording and reproducing the contents of video software and the like in digital format are getting more and more popular. Among them, better accepted on the market are apparatuses having a plurality of attached or built-in recording media and thus having a function of dubbing (copying) the contents thereamong. A hard disc is one of the typical recording media used in such apparatuses, and a DVD is another typical recording medium. The following patent document 1 describes one of known examples of an apparatus capable of recording on a hard disc and a DVD. This patent document mentions that, generally, these recording media greatly differ in recording capacity and poor usability ascribable to the difference is to be improved.

[Patent document 1] Japanese Patent Laid-open Application No. 2004-55010

In the aforesaid known example, a dubbing destination is a recording medium mounted in or attached to the same apparatus. Generally, however, a dubbing destination is not necessarily a recording medium in the same apparatus. The aforesaid document does not deal with such a case.

### SUMMARY

The present invention was devised in consideration of the above-described circumstances, and it is an object of the present invention to provide a recording/reproducing apparatus capable of recording and reproducing the contents in a form of digital data on/from a recording medium and a method of copying the digital contents, and more particularly, to a recording/reproducing apparatus and a method of copying the digital contents which enable copying between apparatuses with easiness and good operability.

A recording/reproducing apparatus according to an aspect of the present invention includes: a first requesting unit which requests, via a network, other recording/reproducing apparatuses connected via the network to transmit information regarding lineups of recording media that the other recording/reproducing apparatuses have; a display unit/operation input unit which notifies the information transmitted in response to the request, thereby prompting a user to select an arbitrary recording medium; a second requesting unit which requests, via the network, the recording/reproducing apparatus having the selected recording medium, out of the other recording/reproducing apparatuses, to transmit information regarding an own status; a judging unit which judges whether or not the selected recording medium is allowed to be a dubbing destination of digital contents, based on the information regarding the status transmitted in response to the request; and a communication/output unit which transmits, via the network, the digital contents to the other recording/reproducing apparatus having the selected recording medium when it is judged that the selected recording medium is allowed to be the dubbing destination.

Therefore, the plural recording/reproducing apparatuses are connected via the network, thereby enabling dubbing between the apparatuses. In this event, the recording/reproducing apparatus as a dubbing source makes two-stage requests in advance to the other recording/reproducing apparatus(es) to transmit the predetermined information. In the first stage, the recording/reproducing apparatus requests a plurality of the other recording/reproducing apparatuses to transmit the information regarding the lineups of their recoding media, not designating any particular recording/reproducing apparatus. In the second stage, a particular one of the other recording/reproducing apparatuses and one of its recording media are designated, and the information regarding the status thereof is requested. Then, it is judged based on the status whether or not the designated recording medium is allowed to be a dubbing destination. When the judgment result is affirmative, the procedure shifts to a dubbing operation. The application of such network utilization and of two-stage information collection makes it possible to select the dubbing destination and shift to the dubbing operation efficiently. Consequently, copying between apparatuses can be performed with easiness and good operability.

A recording/reproducing apparatus according to another aspect of the present invention includes: a first information transmitting unit which outputs, to a network, information regarding a lineup of own recording media when being requested to transmit the information regarding the lineup of the own recording media, the request being transmitted via the network by another recording/reproducing apparatus connected via the network; and a second information transmitting unit which outputs, to the network, information regarding a status when being requested to transmit the information regarding the status, the request being transmitted via the network by the other recording/reproducing apparatus connected via the network.

This recording/reproducing apparatus is a recording/reproducing apparatus as “the other recording/reproducing apparatus” mentioned in the aforesaid “recording/reproducing apparatus according to an aspect of the present invention”. When receiving a transmission request of predetermined information, it outputs corresponding information to the network.

A method of copying digital contents according to still another aspect of the present invention includes: requesting, via a network, other recording/reproducing apparatuses connected via the network to transmit information regarding lineups of recording media that the other recording/reproducing apparatuses have; notifying the information transmitted in response to the request, thereby prompting a user to select an arbitrary recording medium; requesting, via the network, the recording/reproducing apparatus having the selected recording medium, out of the other recording/reproducing apparatuses, to transmit information regarding an own status; judging whether or not the selected recording medium is allowed to be a dubbing destination of digital contents, based on the information regarding the status transmitted in response to the request; and transmitting, via the network, the digital contents to the recording/reproducing apparatus having the selected recording medium when it is judged that the selected recording medium is allowed to be the dubbing destination.

This method of copying the digital contents is a method corresponding to the aforesaid “recording/reproducing apparatus according to an aspect of the present invention”.

According to the present invention, copying between apparatuses with easiness and good operability is enabled in a recording/reproducing apparatus capable of recording and reproducing the contents on/from a recording medium in a form of digital data and in a method of copying the digital contents.

### BRIEF DESCRIPTION OF THE DRAWINGS

FIG. 1 is a block diagram showing the configuration of a recording/reproducing apparatus according to an embodiment of the present invention.

FIG. 2 is a flowchart showing an operational flow of network dubbing in the recording/reproducing apparatus shown in FIG. 1.

FIG. 3 is an explanatory diagram showing how the recording/reproducing apparatus shown in FIG. 1 collects information regarding lineups of recording media via a network.

FIG. 4 is a view showing an example of a screen for displaying the information regarding the lineups of the recording media (=a screen for selection/designation of a recording medium as a dubbing destination) that is collected and displayed by the recording/reproducing apparatus shown in FIG. 1.

FIG. 5 is a flowchart showing Step 22 in the flowchart shown in FIG. 2 in little more detail.

FIG. 6 is an explanatory diagram showing an example of how the recording/reproducing apparatus shown in FIG. 1 collects status information via the network.

FIG. 7 is a flowchart showing Step 25 in the flowchart shown in FIG. 2 in little more detail.

FIG. 8 is a flowchart showing another operational flow of network dubbing in the recording/reproducing apparatus shown in FIG. 1.

FIG. 9 is a view showing an example of a screen displayed at Step 82 in the flow shown in FIG. 8 in the recording/reproducing apparatus shown in FIG. 1.

### DETAILED DESCRIPTION

### EXPLANATION OF EMBODIMENT

Embodiments of the present invention will be described with reference to the drawings, but these drawings are presented only for an illustrative purpose and in no respect, are intended to limit the present invention.

As a form of an embodiment of the present invention, the information regarding the status requested by the second requesting unit can include at least one of information on whether recording prohibition is set, information on whether there remains a predetermined amount of area or larger available for recording, information on whether a current status is recording/reproducing, information on whether there is a predetermined length of time or longer before reserved time for recording, information on whether a graphical user interface (GUI) screen is on display, and information on whether operation lock is set. In consideration of conditions that should be satisfied as the dubbing destination, these pieces of information regarding the status are listed. “Information on whether a GUI screen is on display” is listed because it can be imagined that a user is currently operating the apparatus (that is, the apparatus may possibly start recording itself). “Information on whether operation lock is set” is listed because the setting by the user not to accept any operation is given the highest priority.

As another form, the recording/reproducing apparatus can further include a second display unit/operation input unit which displays a list of digital contents that the own apparatus has, thereby prompting the user to select digital contents to be dubbed when it is judged that the selected recording medium is allowed to be the dubbing destination, and the communication/output unit can transmit, via the network, the selected digital contents to the other recording/reproducing apparatus having the selected recording medium when it is judged that the selected recording medium is allowed to be the dubbing destination. This enables collective dubbing of a plurality of contents, resulting in further improved operability.

As still another form, the digital contents transmitted by the communication/output unit can be data in information-compression format. The information-compression format reduces a transmission amount, resulting in higher dubbing efficiency.

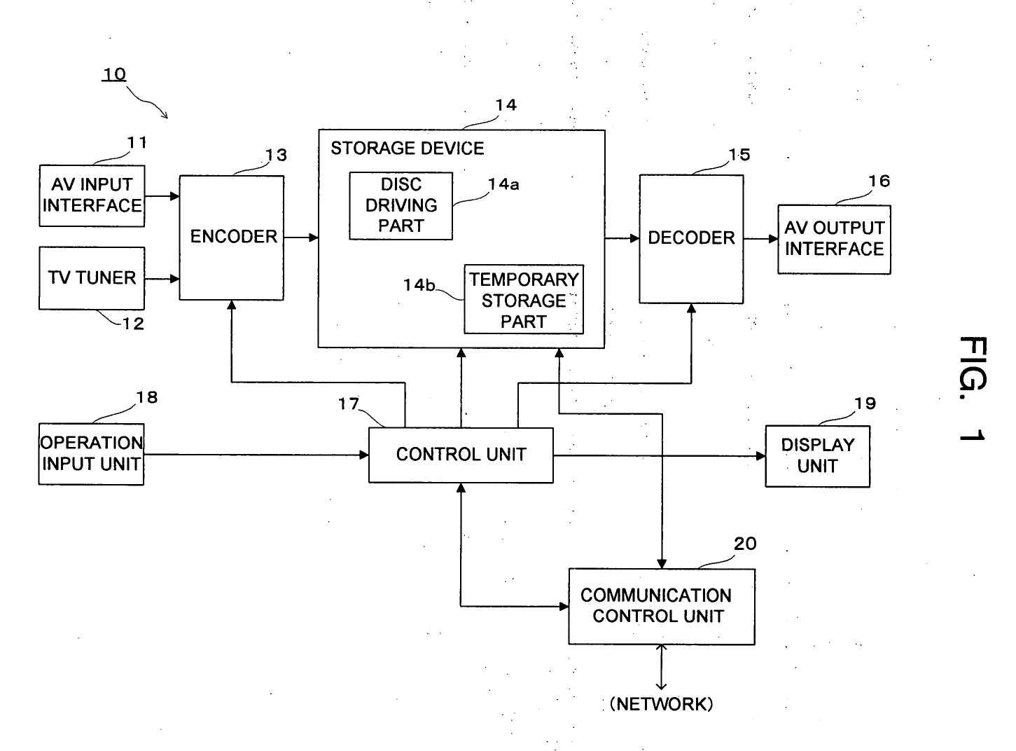

Based on the foregoing, an embodiment of the present invention will be hereinafter described with reference to the drawings. FIG. 1 is a block diagram showing the configuration of a recording/reproducing apparatus according to one embodiment of the present invention. As shown in FIG. 1, the recording/reproducing apparatus 10 has an AV (audio visual) input interface 11, a TV tuner 12, an encoder 13, a storage device 14, a decoder 15, an AV output interface 16, a control unit 17, an operation input unit 18, a display unit 19, and a communication control unit 20. The storage device 14 has a disc driving part 14a and a temporary storage part 14b.

The AV input interface 11 is an interface to which a video information signal and an audio information signal are externally inputted. The inputted signals are sent to the encoder 13. Both analog signals and digital signals are conceivable as the signals inputted to the AV input interface 11. The signals, if they are analog signals, are digital-converted in the AV input interface 11 or in an initial stage of the subsequent-stage encoder 13. The TV tuner 12 takes out the visual information signal and the audio information signal in tune to a radiated and transmitted broadcast wave. The video information signal and audio information signal taken out are sent to the encoder 13. Both an analog output and a digital output are conceivable as an output of the TV tuner 12. The output, if it is an analog output, is digital-converted in an initial stage of the subsequent-stage encoder 13.

The encoder 13 encodes (encoding; including information compression) the sent video information signal and audio information signal to digital signals in order to record the signals on a subsequent-stage recording medium. The encoded signals are sent to the storage device 14. The storage device 14 is capable of having various kinds of recording media attached thereto or built therein. The storage device 14 records the sent signals on the recording media, and reads and outputs the signals recorded on the recording media. The storage device 14 can have as the disc driving part 14a a hard disc driving part (HDD) and/or a DVD driving part. If it is the hard disc driving part, the recording medium is a magnetic disc while if it is the DVD driving part, the recording medium is a DVD which is a removable medium. The temporary storage part 14b buffers the signals when the signals are recorded and read on/from these media, and it is constituted of, for example, a semiconductor memory.

The decoder 15 decodes (decoding; including information expansion) the signals read by the storage device 14. The decoded signals are sent to the AV output interface 16. The AV output interface 16 outputs the signals sent from the decoder 15 as a reproduced video signal and a reproduced audio signal to an external part. Both analog outputs and digital outputs are conceivable as the output signals. The output signals, if they are to be outputted in analog format, are analog-converted in the final stage of the decoder 15 or in the AV output interface 16.

The foregoing is mostly description of the structure as a typical recording/reproducing apparatus. The description below includes the structure having characteristics as the embodiment of the present invention. The control unit 17 centrally controls the operation of the recording/reproducing apparatus 10, and it includes hardware such as an MPU (microprocessing unit) and a memory, and software operating on the hardware. The control unit 17 controls the operations of the encoder 13, the storage device 14, the decoder 15, and so on, and in addition, based on a signal from the operation input unit 18, it requests, via the communication control unit 20 and a network, other recording/reproducing apparatuses, which are connected thereto via the network, to transmits information regarding lineups of recording media that the other recording/reproducing apparatuses have (as a first requesting unit).

Further, based on a signal from the operation input unit 18, the control unit 17 requests, via the communication control unit 20 and the network, the other recording/reproducing apparatus, which is connected thereto via the network, to transmit information regarding its status (as a second requesting unit). Further, based on the information regarding the status sent via the network and the communication control unit 20, the control unit 17 judges whether or not a recording medium of the other recording/reproducing apparatus is allowed to be a dubbing destination (copying destination) of the digital contents (as a judging unit).

The operation input unit 18 is a typical input unit through which a user operates the recording/reproducing apparatus 10, and is used, in particular, for accepting the selection of the recording medium as the dubbing destination. The accepted selection is notified to the control unit 17 by means of a signal. The display unit 19 is a typical notifying unit for displaying the information regarding the recording/reproducing apparatus 10 to a user, and it displays, in particular, the information regarding the lineups of the recording media that the other recording/reproducing apparatuses have, the information being sent via the communication control unit 20 and the control unit 17 in response to the aforesaid request by the first requesting unit.

The communication control unit 20 functions as a communication/output unit outputting to the network a request signal that is inputted thereto from the control unit 17 and as an input unit receiving return signals and digital contents signals outputted to the network from the other recording/reproducing apparatuses. The request signals and the return signals are exchanged with the control unit 17, and the digital contents signal is exchanged with the storage device 14. Note that the communication control unit 20 functions as the communication/output unit of the digital contents signal when this recording/reproducing apparatus 10 corresponds to “the other recording/reproducing apparatus”.

Further, if there exists on the network an outputted request for the transmission of the information regarding the lineup of its own recording media, the communication control unit 20 receives this transmission request and outputs the corresponding information regarding the recording/reproducing apparatus 10 to the network (as a first information transmitting unit). Further, if there exists on the network an outputted request for the transmission of the information regarding the status, the communication control unit 20 receives this request and outputs the corresponding information regarding the recording/reproducing apparatus 10 to the network (as a second information transmitting unit). Information necessary for the information transmission is obtained from the control unit 17 in charge of the central control, when necessary.

Incidentally, examples of the network connectable to the communication control unit 20 are an exclusive LAN (local area network), the Internet (for example, those assigned with IP addresses in which some digits from the uppermost order are identical are targeted), and so on. Hereinafter, the description continues on assumption that the number of the other recording/reproducing apparatuses connected to this network is one or more.

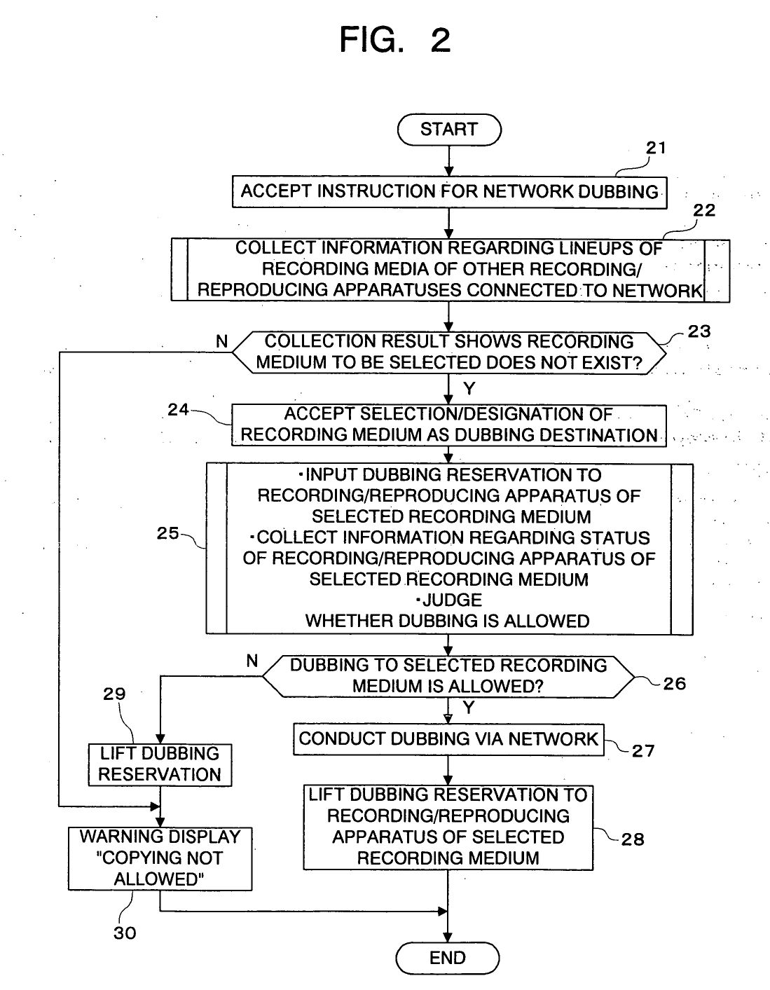

FIG. 2 is a flowchart showing an operational flow of network dubbing in the recording/reproducing apparatus 10 shown in FIG. 1. The operation for dubbing using the network will be described, also referring to FIG. 2.

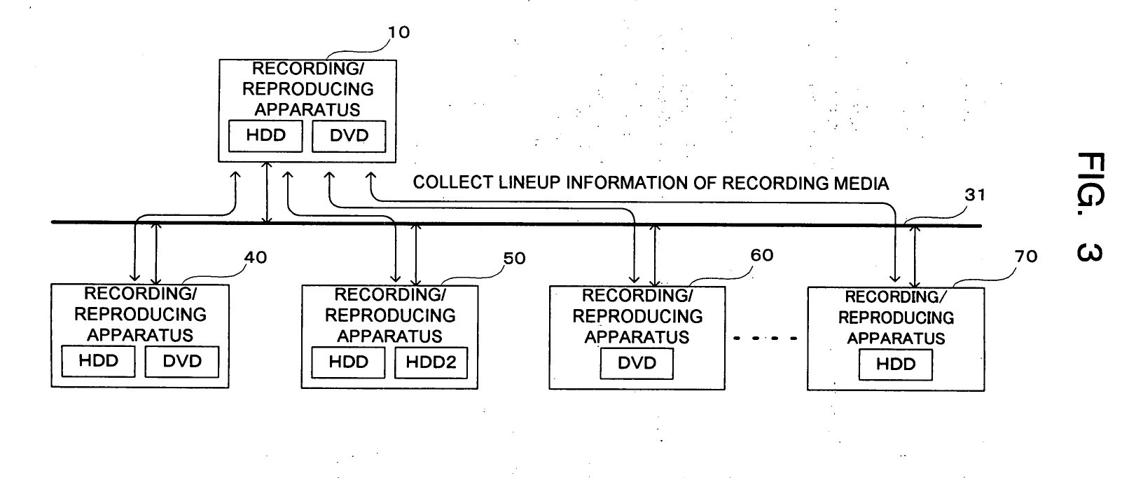

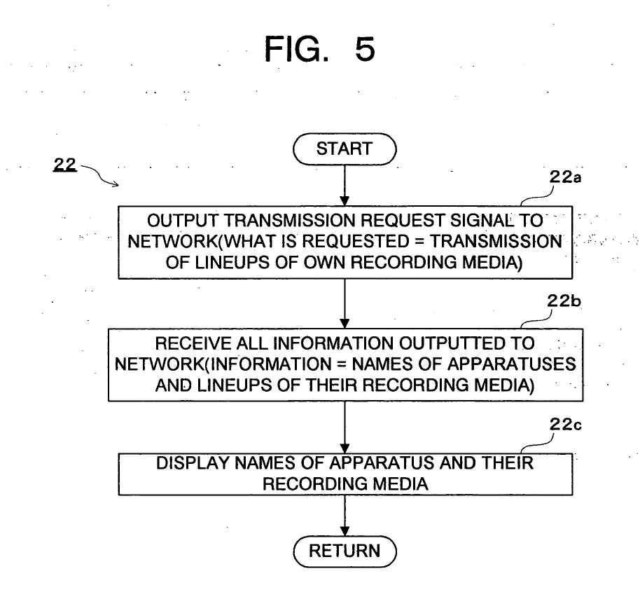

First, an instruction for network dubbing inputted to the operation input unit 18 by a user's operation is accepted (Step 21). In response to this acceptance, the control unit 17 operates to collect the information regarding the lineups of the recording media that the other recording/reproducing apparatuses connected to the network have (Step 22). FIG. 3 shows the collection state on the network at Step 22, which will be detailed later (FIG. 5). FIG. 3 is an explanatory diagram showing how the recording/reproducing apparatus 10 shown in FIG. 1 collects the information regarding the lineups of the recording media via the network. In FIG. 3, recording/reproducing apparatuses 40, 50, 60, . . . , 70 having respective recording media as shown in the drawing are connected to a network 31 besides the recording/reproducing apparatus 10. The recording/reproducing apparatus 10 communicates with each of the recording/reproducing apparatuses 40, 50, 60, . . . , 70.

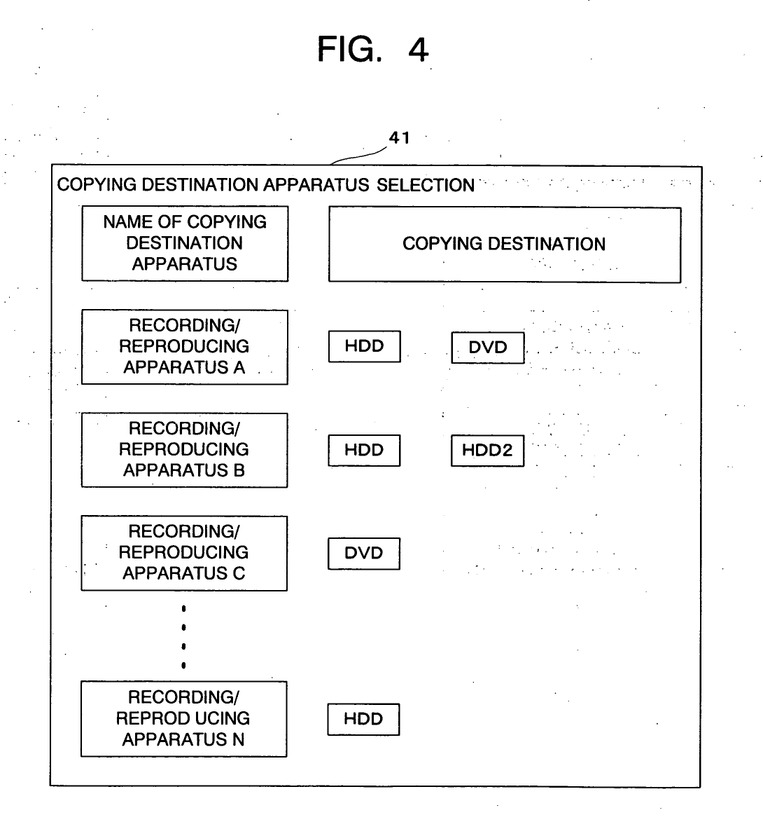

If the result of the information collection by the recording/reproducing apparatus 10 shows that there is no recording medium to be selected (N at Step 23), a warning is displayed on the display unit 19 (Step 30) and this process is terminated. If the result of the information collection shows that there is at least one recording medium to be selected (Y at Step 23), the lineup of its recording media is displayed on the display unit 19, and the selection/designation of the recording medium as a dubbing destination, which is inputted to the operation input unit 18 by a user's operation, is accepted (Step 24). A display example on the display unit 19 here is shown in FIG. 4 (a screen 41 for selection of copying destination apparatus). FIG. 4 is a view showing an example of a screen for displaying the information regarding the lineups of the recording media (=a screen for selection/destination of the recording medium as the dubbing destination) that is collected and displayed by the recording/reproducing apparatus 10 shown in FIG. 1.

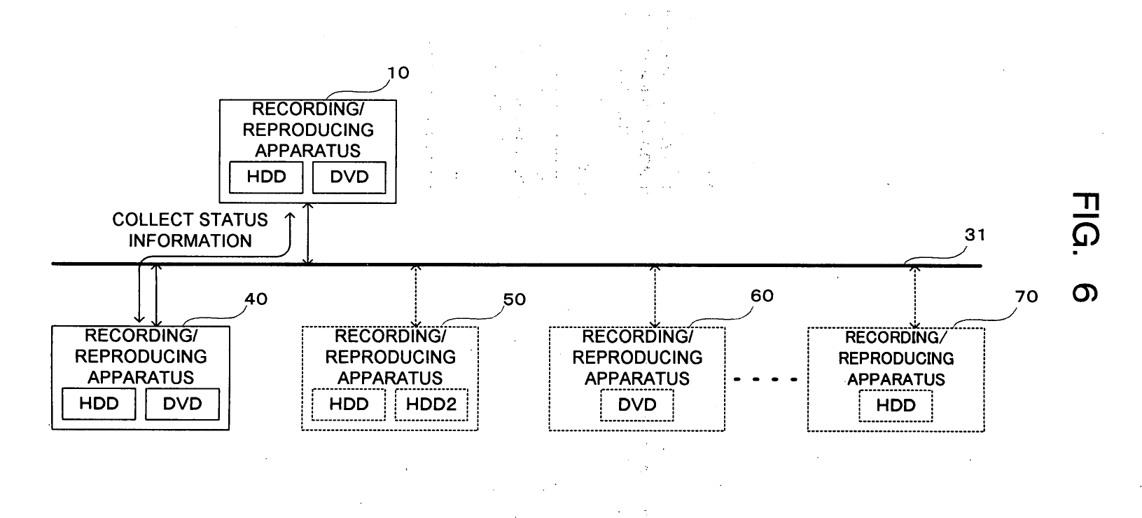

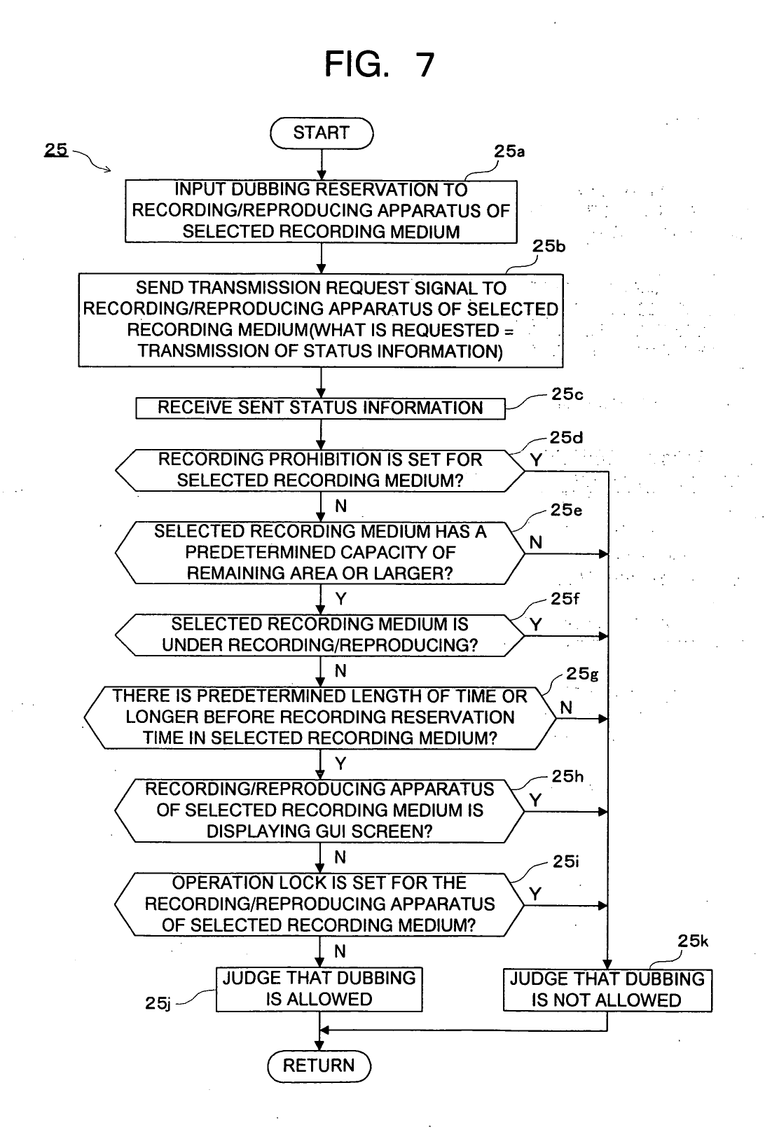

When the user inputs the selection/designation of the recording medium as a desired dubbing destination to the operation input unit 18 while looking at the screen 41 shown in FIG. 4, the recording/reproducing apparatus 10 inputs dubbing reservation to the recording/reproducing apparatus having the selected recording medium (Step 25). Then, the information regarding the status of this recording/reproducing apparatus is collected (the same step). The information collection state on the network is shown in FIG. 6. FIG. 6 is an explanatory diagram showing an example of how the recording/reproducing apparatus 10 shown in FIG. 1 collects the status information via the network. The status means a state as is literally signified and is information based on which permissibility as the dubbing destination is judged. The control unit 17, when the information regarding the status is sent thereto, judges whether or not dubbing is allowed (the same step). Step 25 will be described again (FIG. 7).

At Step 25, unlike at Step 22, information is exchanged only with a specific apparatus, for example, the recording/reproducing apparatus 40 as shown in FIG. 6, and at and after this instant, the other apparatuses, for example the recording/reproducing apparatuses 50, . . . will not be involved in the communication via the network 31. This is preferable in that efficient processing is realized. Further, the other apparatuses, for example, the recording/reproducing apparatuses 50, . . . are free to communicate with one another and thus are free from the communication between the recording/reproducing apparatuses 10, 40.

If the control unit 17 judges that the dubbing is allowed (Y at Step 26), dubbing from the storage device 14 to the selected/designated recording medium is conducted via the communication control unit 20 and further through the network 31 (Step 27). The contents dubbed at this time are not yet decoded, but are digital contents in information-compression format, but dubbing of signals having processed by the decoder 15 is also theoretically possible.

After the completion of the dubbing, the dubbing reservation to the recording/reproducing apparatus (for example, the recording/reproducing apparatus 40) having the selected recording medium is lifted (Step 28). The lifting of the dubbing reservation frees this recording/reproducing apparatus (for example, the recording/reproducing apparatus 40) from the occupied state by the dubbing. If the control unit 17 judges that the dubbing is not allowed (N at Step 26), the dubbing reservation is lifted (Step 29) and a warning is displayed on the display unit 19 (Step 30).

The recording/reproducing apparatus 10 shown in FIG. 1 performs the network dubbing operation in the manner described above. Such network dubbing enables dubbing (copying) between apparatuses with easiness and good operatablity. In particular, dubbing to a DVD which is a removable medium need not intervene each time in dubbing from a HDD of an apparatus to a HDD of another apparatus, resulting in more efficient dubbing.

FIG. 5 is a flowchart showing Step 22 in the flow shown in FIG. 2 in little more detail. As shown in FIG. 5, at Step 22, the recording/reproducing apparatus 10 first outputs a transmission request signal to the network 31 (Step 22a). What is requested here is the transmission of the information regarding the lineups of the recording media that the other recording/reproducing apparatuses 40, . . . have. The outputted transmission request signal reaches each of the recording/reproducing apparatuses 40 . . . . In response to the transmission request signal, each of the recording/reproducing apparatuses 40 . . . outputs to the network 31 the information regarding the own recording media along with its apparatus name.

Next, the recording/reproducing apparatus 10 receives all the pieces of the information outputted to the network 31 (Step 22b). The information here is the information regarding the apparatus names and the lineups of their own recording media. When the information is received, the apparatus names and the names of the recording media that the apparatuses have are displayed on the display unit 19 (Step 22c). This display is, for example, as in the screen 41 for selection of copying destination apparatus shown in FIG. 4, as described above. Specifically, recording/reproducing apparatuses A to N (corresponding to the recording/reproducing apparatuses 40 to 70) are displayed as “apparatus name of copying destination”, and HDDs and DVDs are displayed as “copying destination”.

FIG. 7 is a flowchart showing Step 25 in the flow shown in FIG. 2 in little more detail. As shown in FIG. 7, at Step 25, the dubbing reservation is first inputted via the network 31 to the recording/reproducing apparatus (for example, the recording/reproducing apparatus 40) having the selected recording medium (Step 25a). Next, the transmission request signal is sent via the network 31 to the recording/reproducing apparatus (for example, the recording/reproducing apparatus 40) having the selected recording medium (Step 25b). What is requested here is the transmission of the status information. The recording/reproducing apparatus (for example, the recording/reproducing apparatus 40) receiving the transmission request signal transmits the information regarding its own status via the network 31 to the recording/reproducing apparatus 10, in response to the transmission request signal.

Next, the recording/reproducing apparatus 10 receives the sent status information (Step 25c), and based on the status information, shifts to the judgment on whether dubbing is allowed. The following information is received as the status information in this example as a basis of the judgment on whether dubbing is allowed. Firstly, information on “whether recording prohibition is set for the selected recording medium” is received (Step 25d). Since recording prohibition can be generally set for recording media, this setting is checked. Further, information on “whether the selected recording medium has a predetermined capacity of remaining area or larger” is received (Step 25e). This information is necessary because dubbing is terminated halfway if the remaining area has a capacity less than the predetermined amount. Further received is information on “whether the selected recording medium is under recording or reproducing”. (Step 25f). If the selected recording medium is thus in use, priority is given to such a usage state.

Further received is information on “whether there is a predetermined length of time or longer before reserved time for recording in the selected recording medium” (Step 25g). This is intended for preventing the mode from shifting to a recording mode due to the reservation in the middle of dubbing and for giving priority to the recording by the reservation. Further received is information on “whether the recording/reproducing apparatus of the selected recording medium is displaying a GUI screen” (Step 25h). This information is necessary since the display of the GUI screen indicates that a user is currently operating the apparatus and the apparatus itself may possibly start a recording operation. Further received is information on “whether operation lock is set for the recording/reproducing apparatus of the selected recording medium” (Step 25i). This is intended for giving priority to a user's intentional setting not to accept any operation.

The control unit 17 judges that dubbing is allowed only when the judgment at Step 25i results in an N side after the above-described information judgment (Step 25j). In other cases, it is judged that dubbing is not allowed (Step 25k). Incidentally, these pieces of the status information listed here are only examples. Only part thereof can be adopted as required, or other information can be collected as the status information to be added to the basis of the judgment.

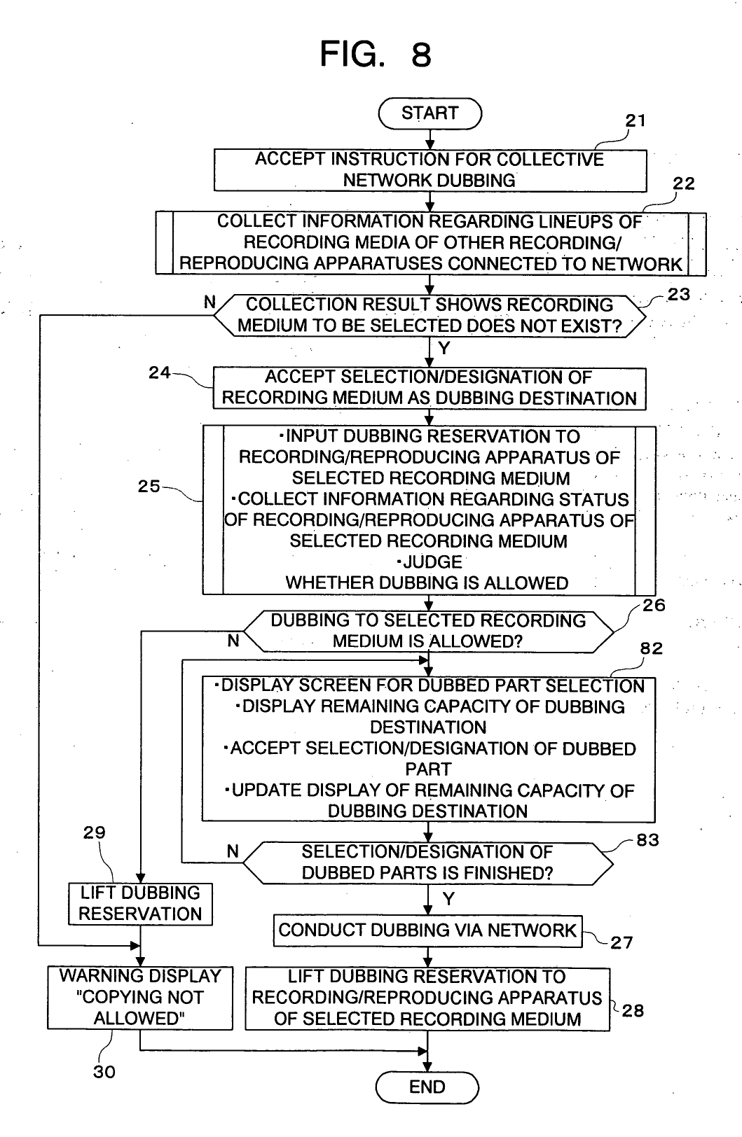

Next, an operational flow different from the operational flow of the network dubbing shown in FIG. 2 will be described with reference to FIG. 8. FIG. 8 is a flowchart showing an operational flow, which is different from the operational flow shown in FIG. 2, of the network dubbing in the recording/reproducing apparatus shown in FIG. 1. In FIG. 8, the same reference numerals are used to designate the same and corresponding processing blocks as those shown in FIG. 2, and description thereof will not be given.

This network dubbing allows a user to select a single or a plurality of digital contents existing in a dubbing source and enables collective dubbing of the selected contents to a recording medium of a specific recording/reproducing apparatus. As shown in FIG. 8, an instruction for collective network dubbing inputted by a user's operation to the operation input unit 18 is first accepted (Step 81). Thereafter, the same processes as in FIG. 2 are performed from Step 22 to Step 26, and the following process is performed at Step 82.

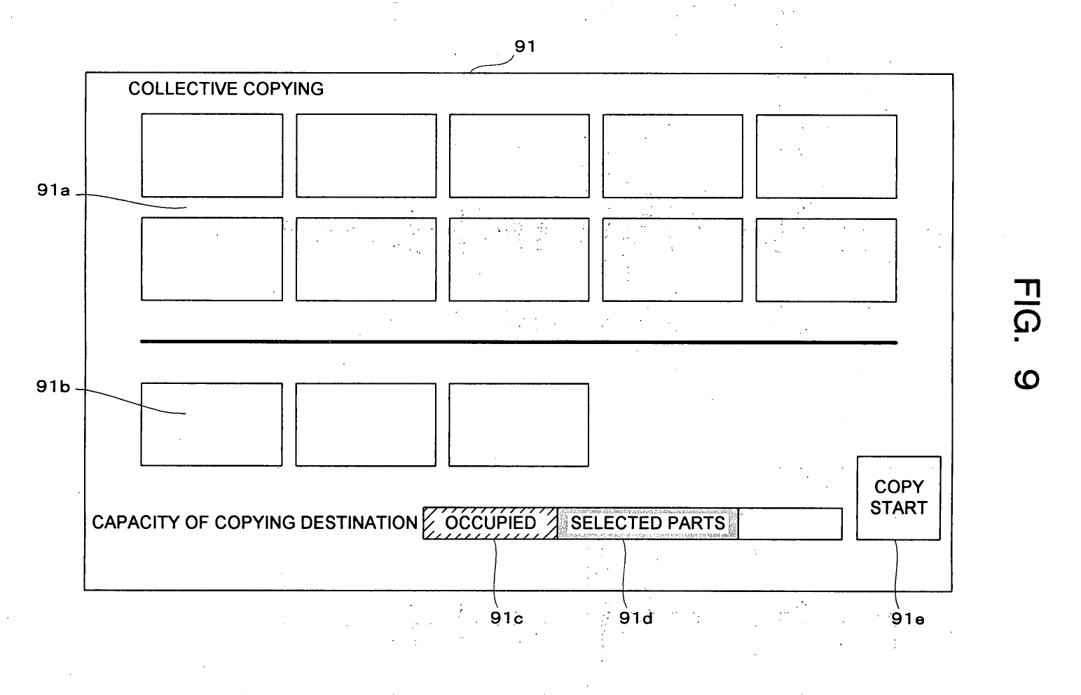

First, on the display unit 19 (second display unit), the control unit 17 displays a screen showing candidate contents for dubbing that its recording/reproducing apparatus has (=displays a screen for selection of parts to be dubbed). An example of this screen display is a copying candidate display area 91a in a collective copying selection screen 91 as shown in FIG. 9. FIG. 9 is a view showing an example of a screen displayed at Step 82 in the flow shown in FIG. 8, in the recording/reproducing apparatus shown in FIG. 1. As an example, ten candidates are displayed in the copying candidate display area 91a in FIG. 9.

Further, on the collective copying selection screen 91, a recording medium already selected is displayed on a lower side as “copying destination capacity”, and its part already occupied by recorded data is indicated by an occupied capacity indicator 91c (display of a remaining capacity of the dubbing destination). When the user selects/designates the contents to be dubbed from the copying candidate display area 91a by inputting through the operation input unit 18 (second operation input unit), the contents are displayed in a selected part display area 91b (=acceptance of the selection/designation of the part to be dubbed). As an example, three contents are displayed in the selected part display area 91b in FIG. 9. At this time, an expected capacity in the dubbing destination occupied by the selected contents is displayed as an indicator 91d of selected part occupying capacity in the “copying destination capacity” (=updating of the display of the remaining capacity of the dubbing destination).

Upon pressing of a copy start button 91e by a user (corresponding to Y at Step 83) after the above-described processes, the contents displayed in the selected part display area 91b are collectively and continuously recorded on the selected recording medium (Step 27). Before the user presses the copy start button 91e (corresponding to N at Step 83), the selection/designation of the contents to be dubbed can be changed. Processes at and after Step 27 area the same as in the description in FIG. 2.

The operational flow of this network dubbing enables collective dubbing of a plurality of contents, resulting in further improved operability.

It should be noted that the present invention is not limited to the specific embodiments described here with reference to the drawings, but it is understood that all changes that come within the range of the following claims are included in the present invention.

What is claimed is:

1. A recording/reproducing apparatus, comprising:
a first requesting unit which requests, via a network, other recording/reproducing apparatuses connected via the network to transmit information regarding lineups of recording media that the other recording/reproducing apparatuses have;
a display unit/operation input unit which notifies the information transmitted in response to the request, thereby prompting a user to select an arbitrary recording medium;
a second requesting unit which requests, via the network, the recording/reproducing apparatus having the selected recording medium, out of the other recording/reproducing apparatuses, to transmit information regarding an own status;
a judging unit which judges whether or not the selected recording medium is allowed to be a dubbing destination of digital contents, based on the information regarding the status transmitted in response to the request; and
a communication/output unit which transmits, via the network, the digital contents to the other recording/reproducing apparatus having the selected recording medium when it is judged that the selected recording medium is allowed to be the dubbing destination.

2. The recording/reproducing apparatus as set forth in claim 1, wherein the information regarding the status requested by the second requesting unit includes at least one of information on whether recording prohibition is set, information on whether there remains a predetermined amount of area or larger available for recording, information on whether a current status is recording/reproducing, information on whether there is a predetermined length of time or longer before reserved time for recording, information on whether a graphical user interface (GUI) screen is on display, and information on whether operation lock is set.

3. The recording/reproducing apparatus as set forth in claim 1, further comprising
a second display unit/operation input unit which displays a list of digital contents that the own apparatus has, thereby prompting the user to select digital contents to be dubbed when it is judged that the selected recording medium is allowed to be the dubbing destination,
wherein the communication/output unit transmits, via the network, the selected digital contents to the other recording/reproducing apparatus having the selected recording medium when it is judged that the selected recording medium is allowed to be the dubbing destination.

4. The recording/reproducing apparatus as set forth in claim 1, wherein the digital contents transmitted by the communication/output unit is data in information-compression format.

5. A recording/reproducing apparatus, comprising:
a first information transmitting unit which outputs, to a network, information regarding a lineup of own recording media when being requested to transmit the information regarding the lineup of the own recording media, the request being transmitted via the network by another recording/reproducing apparatus connected via the network; and
a second information transmitting unit which outputs, to the network, information regarding a status when being requested to transmit the information regarding the status the request being transmitted via the network by the other recording/reproducing apparatus connected via the network.

6. A method of copying digital contents, comprising:
requesting, via a network, other recording/reproducing apparatuses connected via the network to transmit information regarding lineups of recording media that the other recording/reproducing apparatuses have;
notifying the information transmitted in response to the request, thereby prompting a user to select an arbitrary recording medium;
requesting, via the network, the recording/reproducing medium having the selected recording medium, out of the other recording/reproducing apparatuses, to transmit information regarding an own status;
judging whether or not the selected recording medium is allowed to be a dubbing destination of digital contents, based on the information regarding the status transmitted in response to the request; and
transmitting, via the network, the digital contents to the recording/reproducing apparatus having the selected recording medium when it is judged that the selected recording medium is allowed to be the dubbing destination.
